(19) United States
(12) Patent Application Publication
(10) Pub. No.: US 2017/0374076 A1
(43) Pub. Date: Dec. 28, 2017

(54) SYSTEMS AND METHODS FOR DETECTING FRAUDULENT SYSTEM ACTIVITY

(71) Applicant: Viewpost IP Holdings, LLC, Maitland, FL (US)

(72) Inventors: Christopher Pierson, Lake Mary, FL (US); Dan Smith, Oviedo, FL (US)

(21) Appl. No.: 15/195,672

(22) Filed: Jun. 28, 2016

(51) Int. Cl. H04L 29/06; G06Q 50/26

(52) U.S. Cl. CPC H04L 63/102; H04L 65/1073; G06Q 50/265; H04L 63/08

(57) ABSTRACT

Systems and methods are presented for generating intelligence data related to at least one of a group comprising Internet Protocol (IP) addresses, email addresses, domain names, commercial mail receiving agencies, device identifiers, and user system activity, and storing the intelligence data. Systems and methods are further presented for receiving a registration request message from a user via a computing device, with the registration request message comprising identifying information for the user and identifying information for the computing device, analyzing the registration request message to determine whether the identifying information for the user and the identifying information for the computing device, is associated with any data included in the intelligence data, and sending a registration response message indicating whether or not the user is registered, based on the result of analyzing the registration request message to determine whether the identifying information for the user and the identifying information for the computing device, is associated with any data included in the intelligence data.

### TECHNICAL FIELD

The present disclosure relates generally to a mechanism for detecting fraudulent system activity.

### BACKGROUND

The annual worldwide loss from fraudulent system activity (e.g., fake user account creation and use, identity theft, fraudulent transactions, etc.) is in the billions of dollars. Moreover, as conventional systems are moving to conduct more transactions electronically, fraudulent system activity is steadily increasing. Additionally, non-traditional entities, such as social networking type applications, are also providing the ability to conduct conventional transactions electronically (e.g., registering accounts, banking, invoicing, accounting, etc.). Unfortunately, conventional fraud detection methods are not very effective in the electronic space. Moreover, many fraud detection methods are isolated with no way to correlate data and analysis between systems.

### BRIEF DESCRIPTION OF THE DRAWINGS

Various ones of the appended drawings merely illustrate example embodiments of the present disclosure and should not be considered as limiting its scope.

FIG. 1 is a block diagram illustrating a networked system, according to some example embodiments, configured to detect fraudulent system activity.

FIG. 2 is a block diagram illustrating aspects of a server system, according to some example embodiments.

FIG. 3 is a flowchart illustrating aspects of a method, according to some example embodiments, for generating intelligence data and analyzing registration request messages.

FIG. 4 is a flowchart illustrating aspects of a method, according to some example embodiments, for receiving and analyzing access request messages.

FIG. 5 is a flowchart illustrating aspects of a method, according to some example embodiments, for generating alerts related to system activity and generating intelligence data related to a user.

FIGS. 6A-6H illustrate example analysis reports, according to some example embodiments.

FIG. 7 is a block diagram illustrating an example of a software architecture that may be installed on a machine, according to some example embodiments, configured to detect fraudulent system activity.

FIG. 8 illustrates a diagrammatic representation of a machine, in the form of a computer system, within which a set of instructions may be executed for causing the machine to perform any one or more of the methodologies discussed herein, according to an example embodiment.

### DETAILED DESCRIPTION

Systems and methods described herein relate to detecting fraudulent system activity. As explained above, conventional fraud detection methods are not very effective in the electronic space. Moreover, many fraud detection methods are isolated with no way to correlate data and analysis between systems. For example, an entity may have completely separate departments handling different types of security measures for system activity. One department may handle security for account creation, another department for account access, another department for electronic communication security, and yet another department for system activity such as financial transactions or resource use across the system and interaction with other systems. Accordingly, one department may allow a transaction to be conducted because the name, account, address, and the like all checks out according to their security mechanisms. That transaction, however, may be conducted using a device or an Internet Protocol (IP) address that is from a domain linked to fraudulent activity in the electronic communication space. Because the different security measures are so isolated and there is no way to correlate the data between the systems and security mechanisms, the first department allowed a fraudulent transaction to be conducted. Because different security measures are so isolated, and because many conventional fraud detection mechanisms are not effective in the electronic space (e.g., physical signature, physical payment devices, physical identification, etc.), there is an incredible amount of fraud that is not detected or is detected too late to act upon the activity.

Systems and methods described herein provide for a more efficient and effective system by generating intelligence data from multiple discrete sources. The intelligence data is generated by correlating all of the data and enriching the data such that the system can then quickly identify and stop fraudulent activity. In this way the system described herein is able to detect fraudulent activity that is not detected using conventional measures. This is particularly important in environments involving financial transactions, but is effective in any electronic space where users are creating accounts, need system and account access, and utilize secure systems for various types of transactions.

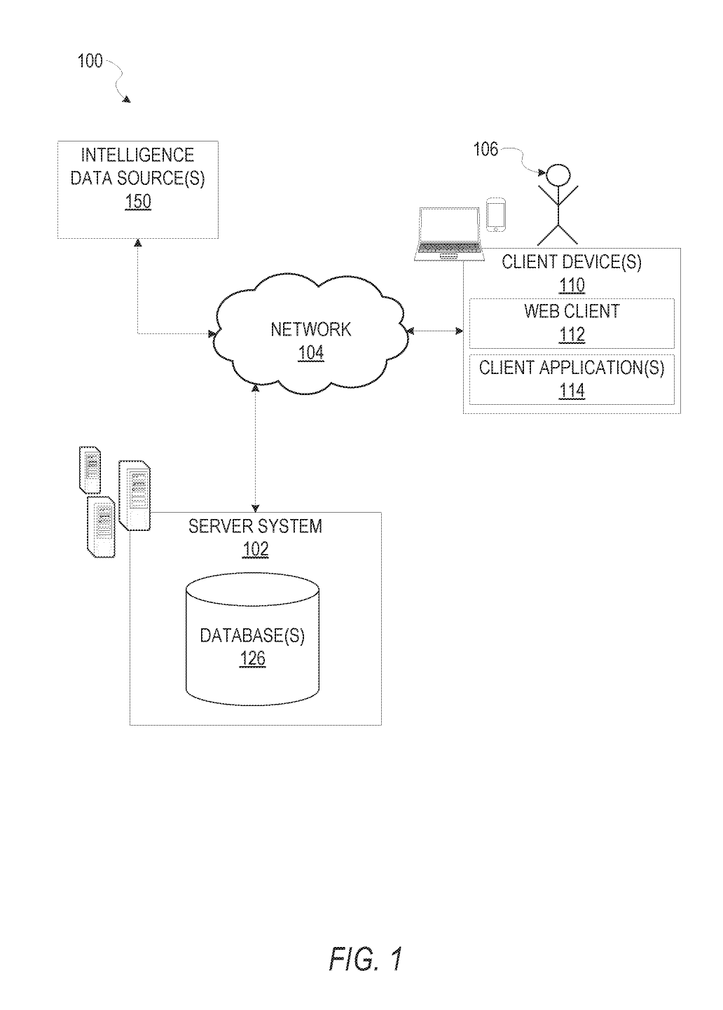

FIG. 1 is a block diagram illustrating a networked system 100, according to some example embodiments, configured to detect fraudulent system activity. The system 100 includes one or more client devices such as client device(s) 110. The client device(s) 110 may comprise, but is not limited to, a mobile phone, desktop computer, laptop, portable digital assistant (PDA), smart phone, tablet, ultra book, netbook, laptop, multi-processor system, microprocessor-based or programmable consumer electronics, game console, set-top box, or any other communication device that a user may utilize to access the networked system 100. In some embodiments, the one or more client device(s) 110 may comprise a display module (not shown) to display information (e.g., in the form of user interfaces). In further embodiments, the client device(s) 110 may comprise one or more of touch screens, accelerometers, gyroscopes, cameras, microphones, global positioning system (GPS) devices, and so forth.

The client device(s) 110 may be a device of a user that is used to create a new account to access one or more systems, logon to one or more systems, prepare invoices, conduct payment transactions, send and receive electronic communication, request and review analysis of potentially fraudulent system activity, and so forth. In one embodiment, the system 100 is a system activity analysis system that generates and correlates intelligence data, among other data, to provide analysis related to potentially fraudulent system activity.

One or more users 106 may be a person, a machine, or other means of interacting with the client device(s) 110. In example embodiments, the user 106 may not be part of the system 100, but may interact with the system 100 via the client device(s) 110 or other means. For instance, the user 106 may provide input (e.g., touch screen input or alphanumeric input) to the client device(s) 110, and the input may be communicated to other entities in the system 100 (e.g., server system 102, etc.) via a network 104. In this instance, the other entities in the system 100, in response to receiving the input from the user 106, may communicate information to the client device(s) 110 via the network 104 to be presented to the user 106. In this way, the user 106 may interact with the various entities in the system 100 using the client device(s) 110.

The system 100 further includes a network 104. One or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

The client device(s) 110 may access the various data and applications provided by other entities in the system 100 via web client 112 (e.g., a browser, such as the Internet Explorer® browser developed by Microsoft® Corporation of Redmond, Washington State) or one or more client applications 114. The client device(s) 110 may include one or more client applications 114 (also referred to as “apps”) such as, but not limited to, a web browser, messaging application, electronic mail (email) application, a social networking application, an e-commerce site application, a financial application, and the like. In some embodiments, one or more applications 114 may be included in a given client device 110 and configured to locally provide the user interface and at least some of the application functionalities. The application(s) 114 are configured to communicate with other entities in the system 100 (e.g., server system 102, etc.), on an as-needed basis, for data and/or processing capabilities not locally available (e.g., registering for a system account, logging into a secure system, conducting payment transactions, analysis of potentially fraudulent system activity, authenticating a user 106, verifying a method of payment, etc.). Conversely, one or more applications 114 may not be included in the client device(s) 110, and then the client device(s) 110 may use its web browser to access the one or more applications 114 hosted on other entities in the system 100 (e.g., server system 102, etc.).

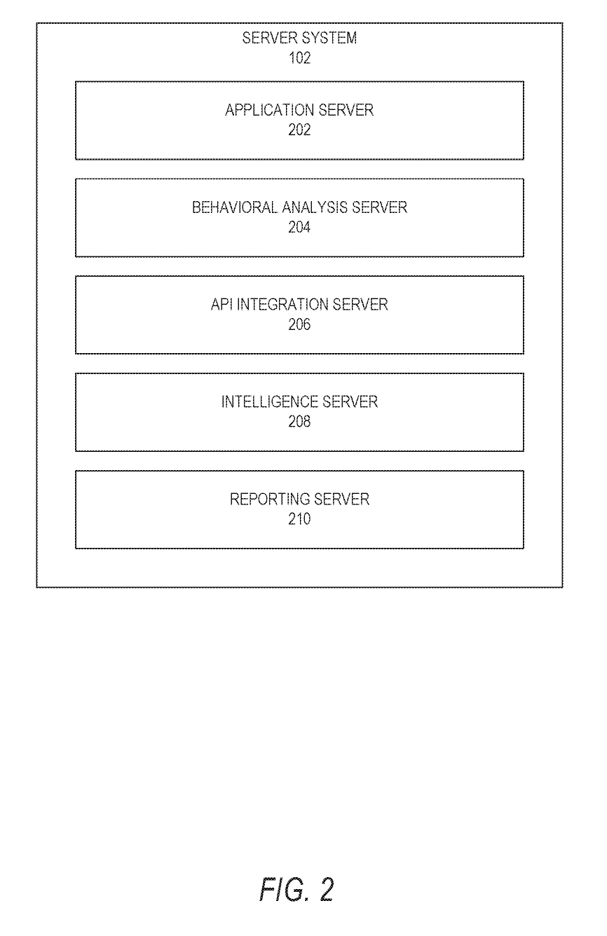

A server system 102 may provide server-side functionality via the network 104 (e.g., the Internet or wide area network (WAN)) to one or more client devices 110. The server system 102 may be a cloud computing environment, according to some example embodiments. In one example, the server system 102 may include one or more servers, as shown in FIG. 2. The example server system 102 of FIG. 2 shows several different servers associated with different functionality. It is understood that all of the functionality could be on one server, some functionality may span across several servers, and so forth.

An application server 202 may provide functionality to perform account registration, authorize system access (e.g., account logon), perform various system activities, and so forth. For example, the application server 202 may receive and analyze registration requests and system access requests, provide functionality for various system activities (e.g., payment transactions, invoice creation and routing, etc.), send registration response messages, send system access response messages, and the like. The application server 202 may access one or more databases 126 to retrieve stored data to use in analyzing registration requests and system access requests, providing functionality for various system activity, and to store results of analysis and system activity (e.g., all system activity may be captured and stored in system activity logs).

A behavioral analysis server 204 may provide functionality for building and analyzing user profiles. For example, the behavioral analysis server 204 may provide functionality to build a user profile utilizing identifying information associated with a user, identifying information for one or more computing devices associated with the user, IP addresses associated with the computing devices and user, geolocations associated with the computing device and user, internet service provider(s) (ISP) associated with the computing device, system activity associated with the user, and so forth.

An Application Programming Interface (API) integration server 206 may provide functionality to support interfacing with external entities and internal applications and servers. For example, the API integration server 206 may support sending a message to a user (e.g., email message, text message (e.g., SMS, MMS, etc.)), for a dual factor authentication process or multi-layer authentication, for various notifications or alerts, and so forth. The API integration server 206 may provide functionality to interface with a communication service to route the message to the user.

In another example, the API integration server 206 may provide functionality to interface with one or more intelligence data source(s) 150 (shown in FIG. 1) to request and receive information from the one or more intelligence data source(s) 150. For example, the API integration server 206 may periodically request intelligence data and store the intelligence data, or the API integration server 206 may request specific intelligence data in real time (e.g., substantially real time).

In yet another example, the API integration server 206 may provide functionality to interface with other servers in server system 102 and with one or more databases 126. For example, the API integration server 206 may provide an interface for an application hosted by application server 202 to support calls into one or more databases 126 (e.g., to access intelligence data, to correlate various intelligence data, to build a user profile, generate intelligence data related to a user, to correlate an IP address with a domain name, geolocation, ISP, etc.).

An intelligence server 208 may provide functionality for generating intelligence data. For example, the intelligence server 208 may correlate and enrich data from external entities and internal applications, servers, and databases to generate intelligence data. Intelligence data may comprise information related to IP addresses, email addresses, domain names, commercial mail receiving agencies, device identifiers, user system activity, user behavior profile, and the like. Reputation scoring and cybersecurity threat scoring data may also be used to further enrich intelligence data.

A reporting server 210 may provide functionality for analyzing intelligence data and providing reports or requested data based on the analysis. The reporting server 210 may utilize one or more databases 126 for providing the analysis and reporting. For example, the reporting server 210 may access intelligence data stored in one or more databases 126 and aggregate and summarize the intelligence data into more manageable groups of data. The reporting server 210 may provide analytical tools for analyzing system activity or a particular user activity, and the like.

Referring again to FIG. 1, the server system 102 may be communicatively coupled with one or more database(s) 126. The database(s) 126 may be storage devices that store information such as user identifying information, device identifying information, IP addresses, information associated with IP addresses (e.g., geolocation, domain name, ISP, etc.), email addresses, domain names, commercial mail receiving agencies, device identifiers, user system activity (e.g., user input, data, transactions, etc.), email risk scores, analysis of registration request messages, analysis of system response messages, user profile information, intelligence data related to a user, application telemetry (e.g., recording of events that occur in an application or website), and the like. The security analysis server 120 may access one or more databases 126 to retrieve stored data to use in analysis and to store results of such analysis.

The system 100 includes one or more intelligence data source(s) 150. The one or more intelligence data source(s) 150 may be third party services that are separate entities from the server system 102 or may be associated with the same entity as server system 102 (or both). The one or more intelligence data source(s) 150 may be a source of one or more of the following types of data: IP addresses that are known to be fraudulent or that are associated with suspicious activity, email addresses (or other messaging addresses) that are known to be fraudulent or that are associated with suspicious activity, domain names associated with fraud or suspicious activity, domain names associated with temporary mail inboxes, commercial mail receiving agencies (e.g., a mail box operation that receives mail for a user instead of the mail being received at a user's own address), device identifiers of known fraud, large company (e.g., Fortune 1000 companies or other specially identified companies) data (e.g., device identifiers and IP addresses) that are tied to fraud, email address risk evaluation, web anonymizers (e.g., exit nodes), data associated with an IP address (e.g., domain name, geolocation, ISP, etc.), device recognition (e.g., identifying personal computing devices globally), device reputation (e.g., assigned reputation component for a device), and the like. For example, an intelligence data source 150 may be an email risk evaluation service that assigns a risk score to an email address indicating the risk that the email address is fraudulent or has been used in suspicious activity.

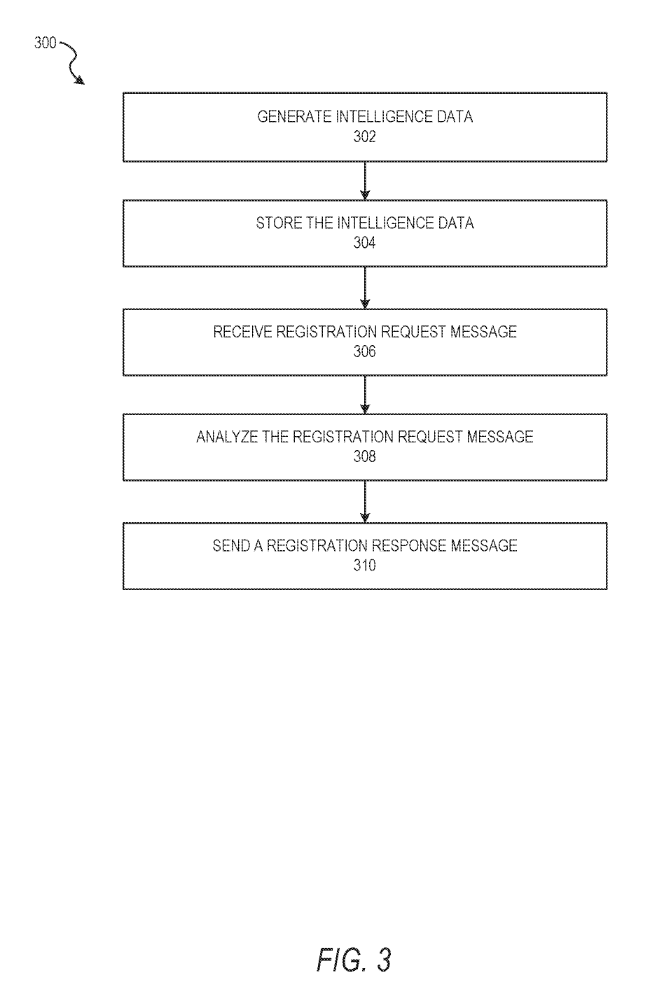

FIG. 3 is a flow chart illustrating aspects of a method 300, according to some example embodiments, for generating intelligence data and analyzing registration request messages. For illustrative purposes, method 300 is described with respect to the networked system 100 of FIG. 1 and the server system of FIG. 2. It is to be understood that method 300 may be practiced with other system configurations in other embodiments.

At operation 302, a server computer of server system 102 generates intelligence data. In one example, the server computer (e.g., intelligence server 208) may interface with various data sources such as intelligence data sources 150 (e.g., via API integration server 206). The server computer may receive and request data from the multiple intelligence data sources 150. For example, the server computer may request data from an email risk evaluation data source that assigns risk scores to email addresses. Intelligence data sources 150 may include email risk evaluation data sources, IP address data sources, domain data sources, device identifier data sources, commercial mail receiving agencies data sources, user system activity data sources, social media accounts, and so forth. The server computer of server system 102 may also access data internal to the server system 102. For example, the server computer of server system 102 may utilize one or more databases 126 to access stored data related to user records and usage data (e.g., user identifying information, transaction details, etc.), user system activity (e.g., account access records and results, IP addresses and/or device identifiers used for system access, registration results, etc.), data associated with fraud identified in or by the server system 102, data associated with IP addresses (e.g., domain name, geolocation, ISP, etc.), and the like.

In one example embodiment, the server system 102 may correlate data from intelligence data sources 150, data internal to the server system 102, etc., on a periodic basis (e.g., daily, weekly, monthly, etc.). In another example embodiment, the server system 102 may gather data from intelligence data sources 150 on a periodic basis and store the data (e.g., in one or more databases 126) to later correlate and generate intelligence data. In this way the server system 102 may correlate and generate intelligence data in advance or on-demand.

At operation 304, the server computer of server system 102 stores the intelligence data. For example, the server computer of server system 102 may store the intelligence data in one or more databases 126.

A user 106 may want to register with a product or service. For example, the user 106 may want to register with a service to exchange invoices and payments electronically. The user may use a client application 114 or access a website via web client 112 to register for the service. The application 114 or website may provide the user 106 with an interface for entering user information to create an account. For example, the user may be asked to provide information, such as a name, email address, phone number, password, company name, and the like. Once the user enters the information, the user 106 may select an option (e.g., via a button, drop down menu, etc.) to create the account. A registration request message including the information may be sent from the client device 110 to a server computer of server system 102 (e.g., application server 202).

At operation 306, the server computer of server system 102 receives the registration request message from the user via a computing device (e.g., client device 110). The registration request message may comprise identifying information for the user and identifying information for the computing device. Identifying information for the user may include a name, email address, password, phone number, physical address, company name, and the like. Identifying information for the computing device may include a unique identifier associated with the computing device, an IP address associated with the computing device, and so forth.

At operation 308, the server computer of server system 102 analyzes the registration request message. In one example, the server computer of server system 102 analyzes the registration request message to determine whether the identifying information for the user and the identifying information for the computing device are associated with any data included in the intelligence data. For example, the server computer of server system 102 may compare the identifying information for the user (e.g., name, phone number, address, etc.) and/or the identifying information for the computing device (e.g., unique identifier for the computing device, IP address, etc.) against intelligence data to determine whether any of the identifying information is associated with the identifying information for the user or computing device. The server computer of server system 102 may utilize intelligence data already stored in one or more databases 126. In addition, or in the alternative, the server computer of server system 102 may request information about the identifying information of the user and/or computing device directly from one or more intelligence data source(s) 150 in real time (e.g., substantially real time) to determine up-to-date status associated with the identifying information of the user and/or computing device.

In one example, the server computer of server system 102 compares the user provided email address to the intelligence data to determine if there is any fraud or suspicious behavior associated with the email address. For instance, the computer of server system 102 may determine an email risk score associated with the email address, or determine that the email address was used previously to perform a fraudulent activity (e.g., to open a fake account, to fraudulently transfer money, to send a fake invoice, etc.).

In another example, the server computer of server system 102 analyzes the IP address to determine a domain name. The server computer of server system 102 may then search for the domain name to determine if there is any fraud or suspicious behavior associated with that domain name. In one example, the server computer of server system 102 can utilize intelligence data already stored in one or more databases 126. In another example, the server computer of server system 102 may request information about the domain name directly from one or more intelligence data source(s) 150 in real time (e.g., substantially real time) to determine up-to-date status associated with the domain name.

In another example, the server computer of server system 102 analyzes the IP address to determine that the IP address is associated with a web anonymizer that masks an IP address so that the true IP address is not shown. The server computer of server system 102 may want to track a user who utilizes a web anonymizer or block the user.

In yet another example, the server computer of server system 102 may correlate the IP address to a geolocation to determine whether the geolocation is a suspicious location. For example, if the user has identifying information associated with the United States and the geolocation is determined to be China or Russia, the server computer of server system 102 may determine that the geolocation is suspicious and deny the registration request.

The server computer of server system 102 may determine that the user should not be registered based on the result of analyzing the registration request message to determine whether the identifying information for the user and the identifying information for the computing device are associated with any data included in the intelligence data. For example, the server computer of server system 102 may determine that the IP address is associated with fraudulent activity, the domain name is associated with fraudulent activity, the email address has a high risk score, the user name was associated with multiple attempts to register an account, the user address was associated with a commercial mail receiving agency, or any combination of these or other factors. Based on the determination that the user should not be registered, the server computer of server system 102 may generate additional intelligence data to include the information from the registration request as associated with a fraudulent attempt to register an account. The server computer of server system 102 may then store the additional intelligence data in one or more databases 126.

In one example embodiment the server system 102 may generate an alert to trigger a review by an agent of the registration request and intelligence data. In another example embodiment the server system 102 may automatically deny the registration request.

The server computer of server system 102 may determine that the user should be registered based on the result of analyzing the registration request message to determine whether the identifying information for the user and the identifying information for the computing device are associated with any data included in the intelligence data. The server computer of server system 102 may start building a user profile using the identifying information for the user and the identifying information for the computing device. The profile may also include further information determined from analysis of the identifying information for the user and computing device. For example, the profile may include a geolocation, other accounts or information obtained from the intelligence data, and the like.

In one example, the server computer of server system 102 may determine that the user should be placed on a watch list based on the result of analyzing the registration request message to determine whether the identifying information for the user and the identifying information for the computing device are associated with any data included in the intelligence data. For example, the server computer of server system 102 may identify a characteristic of the identifying information for the user and/or the computing device that is not risky enough to deny registration, but that should be monitored for any further suspicious activity.

In another example, the server computer of server system 102 may cause a monitoring device to be installed on the computing device. For example, the server computer of server system 102 may cause information (e.g., data in the form of a cookie, web bug, beacon, gif, flash cookies, etc.) to be stored on the user's computing device. This will allow the server computer of server system 102 to access user information. For example, the monitoring device may contain a unique randomly generated string of data that is associated with the user and/or computing device. In another example, the monitoring device may contain unique identifiers to capture a user experience with a website, application, etc. This information may also be used to share and exchange data with third parties. The monitoring device may be used to prevent false positives for activity that would otherwise be considered higher risk, to tie a single user or device across multiple accounts, and so forth. For example, the system may detect the user's geolocation to be in the United Kingdom and determine that he is using the same device (based on the data contained in the monitoring device) he typically uses to access the system. Even though the user typically has a geolocation in the United States, the activity may not be deemed higher risk because the user is likely traveling with his computer (vs. a user who has stolen a computer and taken it the United Kingdom to access the system). In another example, the server computer of server system 102 may use data generated by the monitoring device to detect that a single user using the same computing device is trying to access multiple accounts.

Continuing to refer to FIG. 3, the server computer of server system 102 sends a registration response message, at operation 310, indicating whether or not the user is registered, based on the result of analyzing the registration request message to determine whether the identifying information for the user and the identifying information for the computing device are associated with any data included in the intelligence data.

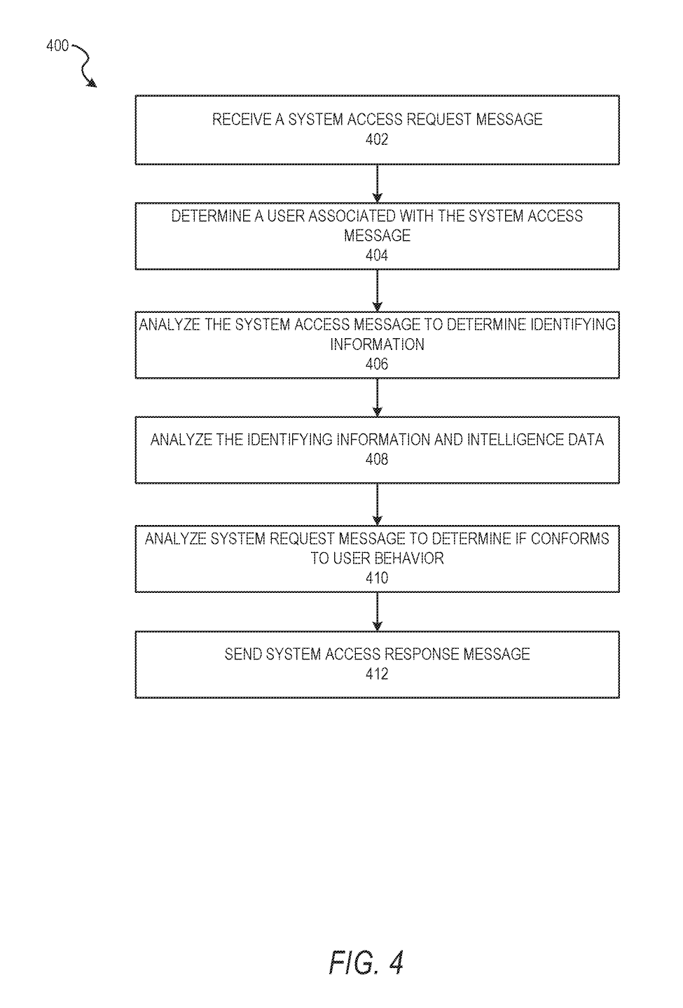

FIG. 4 is a flow chart illustrating aspects of a method 400, according to some example embodiments, for receiving and analyzing access request messages. For illustrative purposes, method 400 is described with respect to the networked system 100 of FIG. 1 and server system of FIG. 2. It is to be understood that method 400 may be practiced with other system configurations in other embodiments.

At operation 402, a server computer of server system 102 (e.g., application server 202) receives a system access request message from a computing device associated with a user (e.g., a client device 110). The system access request message may comprise a username (e.g., a unique indicator such as an email address) and a password. The system access request message may further comprise additional identifying information for the user (e.g., information obtained from a monitoring mechanism on the user's device). In addition, the system access request message may comprise identifying information for the computing device (e.g., unique device identifier, IP address, etc.). At operation 404, the server computer of server system 102 determines a user associated with the system access message. For example, the server computer of server system 102 may access user data in one or more databases 126 to look up the username and/or password and determine the associated user.

At operation 406, the server computer of server system 102 analyzes the system access message to determine identifying information for the user and identifying information for the computing device. The server computer of server system 102 analyzes the identifying information for the user and the computing device to determine whether it is associated with any data in the intelligence data, at operation 408. For example, the server computer of server system 102 may determine that the IP address was associated with a fraudulent activity, the domain name is associated with fraudulent activity, the email address has a high risk score, the user name was associated with multiple attempts to access an account, or any combination of these or other factors.

At operation 410, the server computer of server system 102 analyzes the system request message to determine if it conforms to user behavior. For example, the server computer of server system 102 may compare the information in the system request message to a user profile for the user to determine whether it conforms with typical user behavior (e.g., device previously used to access system, device previously been associated with the user, similar geolocation, similar IP address, similar geography (e.g., as determined from the IP address), same ISP, etc.).

Based on various factors, such as the result of the analysis of identifying information, intelligence data, and user behavior profile, the server computer of server system 102 may allow system access, deny system access, or may require additional security (e.g., additional authentication challenge questions, two-step verification by sending a code to the user to enter, etc.). System access may be allowed after a successful response to additional security, or denied after an unsuccessful response to the additional security.

At operation 412, the server computer of server system 102 sends a system access response message indicating whether or not the user is authorized to access the system based on the result of the analyzing the system access request message to determine whether the identifying information for the user and the identifying information for the computing device is associated with any data included in the intelligence data, and the analyzing the system access request message to determine whether it conforms to user behavior based on a user profile for the user.

If the server computer of server system 102 allows access (including allowing access after additional security), the data from the allowed access may be added to the user behavior profile (e.g., device identifiers, IP address, geolocation, ISP, domain name, etc.).

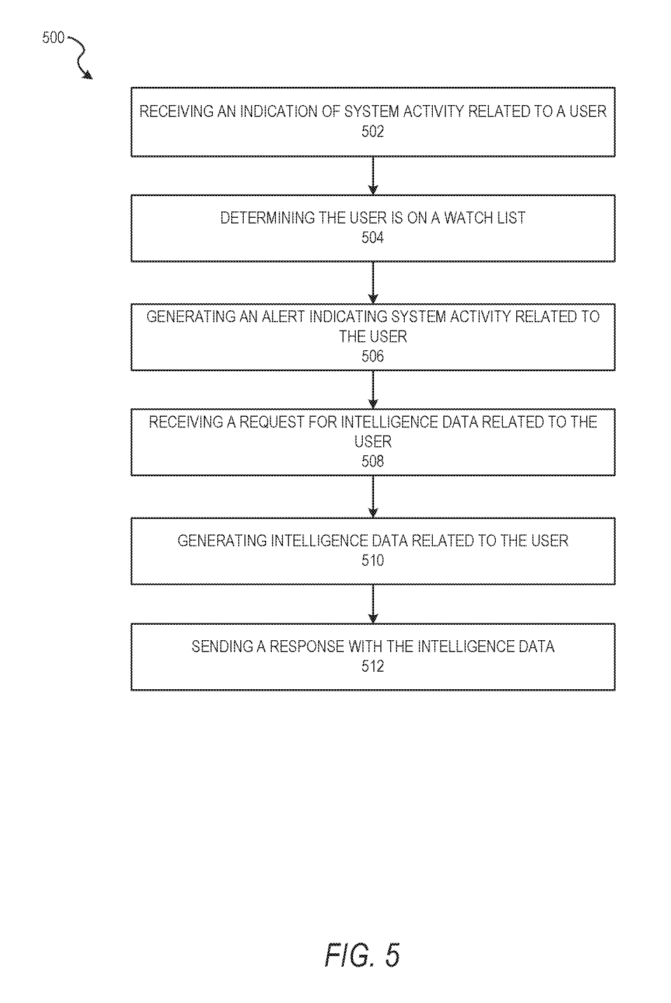

FIG. 5 is a flow chart illustrating aspects of a method 500, according to some example embodiments, for generating alerts related to system activity and generating intelligence related to a user. For illustrative purposes, method 500 is described with respect to the networked system 100 of FIG. 1. It is to be understood that method 500 may be practiced with other system configurations in other embodiments.

At operation 502, a server computer of server system 102 receives an indication of system activity related to a user. For example, a user 106 may be trying to access the system (e.g., logging on), conducting a transaction in the system (e.g., creating an invoice, conducting a payment transaction, etc.), requesting account information, and the like. The user 106 may have been previously put on a watch list because of potentially suspicious behavior during account registration and creation, system access, system activity (e.g., suspicious transaction, high dollar transaction, etc.), and so forth. At operation 504, the server computer of server system 102 determines whether or not the user 106 is on a watch list. For example, the server computer of server system 102 may look up the username on the watch list to determine that the user 106 is on the watch list. Once the server computer of server system 102 determines that the user 106 is on a watch list, it generates an alert indicating the system activity related to the user 106, at operation 506. The alert may then be sent to a computing device (e.g., client device 110) so that a user 106, such as a security analyst, may receive and process the alert and do further research on the system activity or the user.

For example, the security analyst may receive the alert and request intelligence data related to the user 106. The server computer of server system 102 receives a request for intelligence data related to the user 106, at operation 508. The server computer of server system 102 generates intelligence data related to the user 106, at operation 510. For example, the server may correlate intelligence data related to the user 106 and retrieve the user profile data and the like to generate the intelligence data related to the user. The server computer of server system 102 then provides the intelligence data related to the user to the security analyst (e.g., via client device 110). For example, at operation 512, the server computer of server system 102 sends a response with the intelligence data related to the user. The response may include the details of the intelligence data related to the user, or the response may include instructions or other means (e.g., link, button, etc.) to access the intelligence data related to the user.

The server system 102 provides various mechanisms for reporting general analysis of intelligence data and providing specific intelligence data related to a particular user, device, IP address, company, and the like. For example, the server system 102 may take application logs that log all system activity (e.g., logon attempts, logon successes, device identifiers associated with logon attempts, IP addresses related to various transactions, etc.) and generate statistics, graphs, charts, summaries, and the like from the data. The server system 102 may do this automatically on a periodic basis to provide regular reporting on various aspects of the system, or the system 102 may generate a report in response to a specific request from an analyst (e.g., via a client device 110). Reporting analysis may be entirely customizable to suit the needs of the analyst or company. For example, the reporting may be a system wide view reporting any anomalies in the system (e.g., scheduled database query jobs designed to find high risk activity that exists in the system), or the reporting may be specific to a user, device, IP address, and the like.

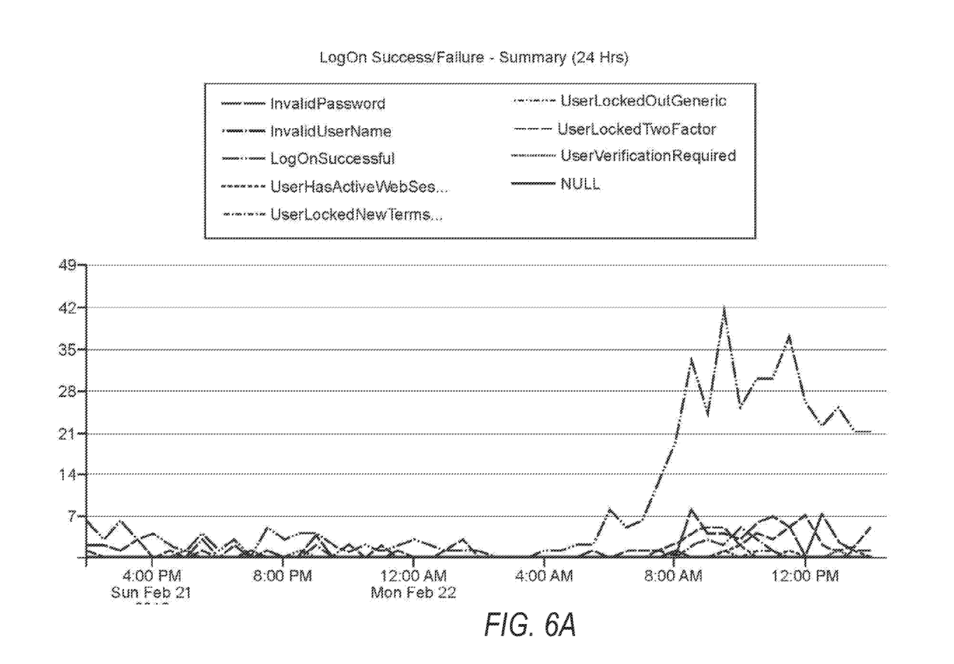

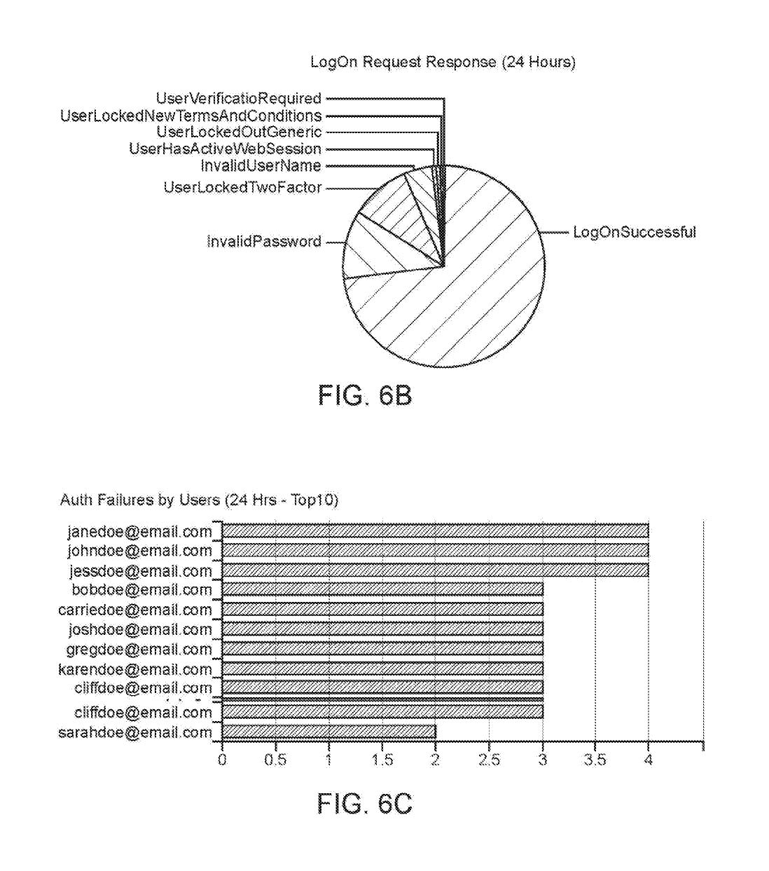

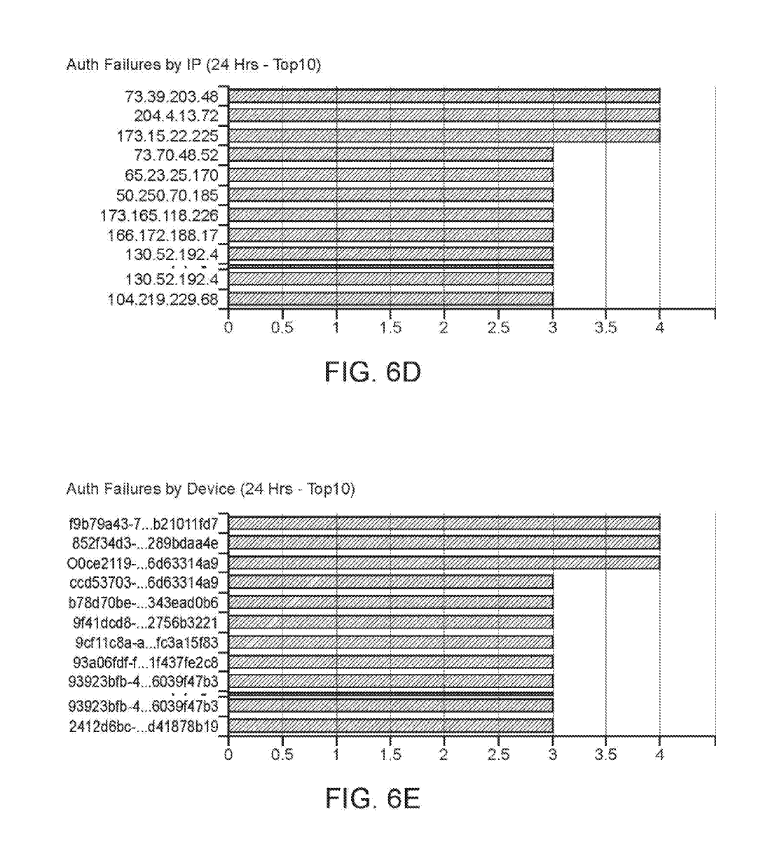

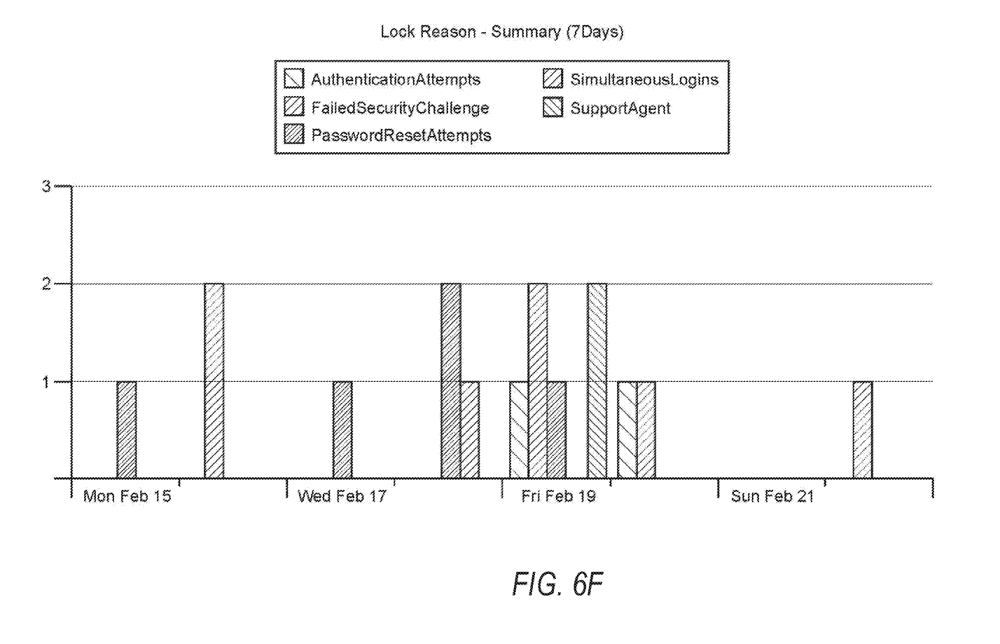

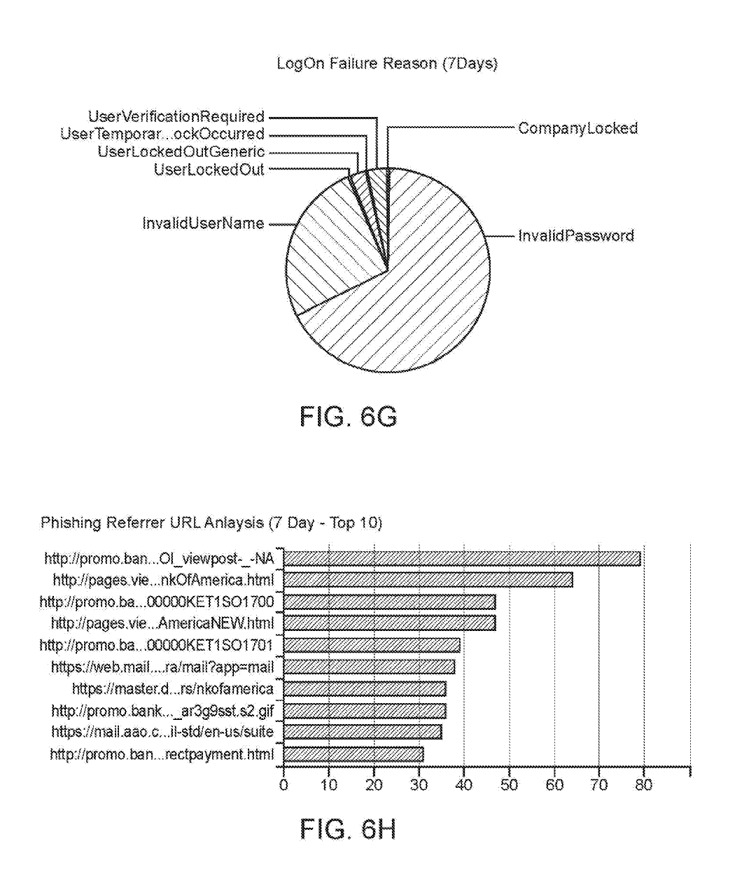

In one example, a dashboard is provided that a security analyst can access to view results of various analysis or specific intelligence data, as shown in FIGS. 6A-6J. FIG. 6A shows an example dashboard with a graph illustrating logon successes and failures within the last 24 hours. A related example dashboard may contain the details about the logon successes and failures within the last 24 hours. For example, the details may be in a table with the date and time for each logon attempt, the response (e.g., logon successful user locked two factor, logon failed, etc.), action required (e.g., none, two factor authentication required, verify account, etc.), the user name associated with the logon attempt, and so forth. The logon data may also be displayed in different time frames (e.g., 24 hours, 7 days, 30 days, 1 year, etc.) and at various levels of detail.

FIG. 6B shows an example dashboard with a pie chart illustrating logon request response types over the last 24 hours. The logon data may also be displayed in different time frames (e.g., 24 hours, 7 days, 30 days, 1 year, etc.) and at various levels of detail.

FIGS. 6C-6E show example dashboards with charts illustrating authorization failures by user, authorization failures by IP, and authorization failures by device. A related example dashboard may contain the details about the authorization failures (e.g., session IP, user name, device identifier, etc.). The data may be displayed in different time frames (e.g., 24 hours, 7 days, 30 days, 1 year, etc.) and at various levels of detail.

FIG. 6F shows an example dashboard with a chart summarizing lock reasons (e.g., the reasons a user is locked out of his account) for the last 7 days. A related example dashboard may contain the details about the lock reasons (e.g., date, time, user name, lock reason, etc.). The data may be displayed in different time frames (e.g., 24 hours, 7 days, 30 days, 1 year, etc.) and at various levels of detail.

FIG. 6G shows an example dashboard with a pie chart summarizing logon failure reasons in the last 7 days. A related example dashboard may contain the details about the logon failure reasons (e.g., date, time, user name, failure reason, etc.). The data may be displayed in different time frames (e.g., 24 hours, 7 days, 30 days, 1 year, etc.) and at various levels of detail.

FIG. 6H shows an example dashboard with a chart summarizing the top ten phishing referrer Uniform Resource Locator (URL) analysis over the last 7 days. A related example dashboard may contain the details related to the analysis (e.g., date, time, URL, etc.). The data may be displayed in different time frames (e.g., 24 hours, 7 days, 30 days, 1 year, etc.) and at various levels of detail.

As described above, the server system 102 provides a customizable reporting system. Accordingly, a security analyst can determine exactly what type of reporting he wants, how often, what time frames, what level of detail, and so forth. Other examples of reports may include payment transaction or financial related data and analysis (e.g., payment summary of payor or payee, payment dollars trend, payment details, types of payments, etc.), registration related analysis and reports (e.g., registration by IP, company registrations, etc.), login data, user activity, authentication enrollment, and so forth.

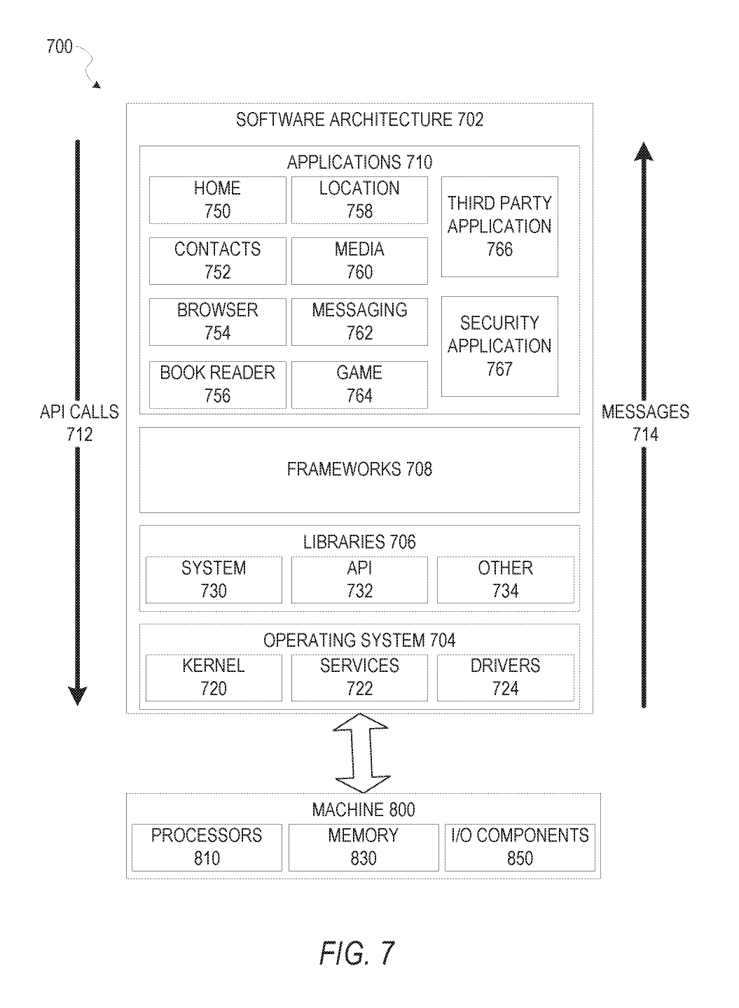

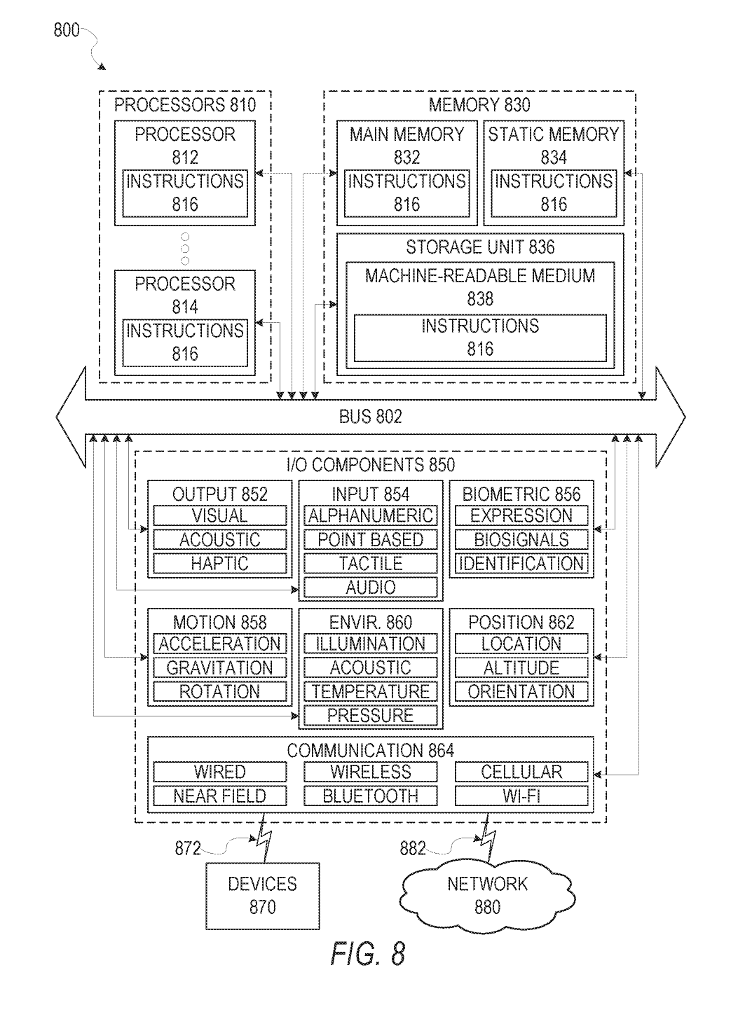

FIG. 7 is a block diagram 700 illustrating software architecture 702, which can be installed on any one or more of the devices described above. For example, in various embodiments, client devices 110, server system 102, application server 202, behavioral analysis server 204, API integration server 206, intelligence server 208, and reporting server 210 may be implemented using some or all of the elements of software architecture 702. FIG. 7 is merely a non-limiting example of a software architecture, and it will be appreciated that many other architectures can be implemented to facilitate the functionality described herein. In various embodiments, the software architecture 702 is implemented by hardware such as machine 800 of FIG. 8 that includes processors 810, memory 830, and Input/Output (I/O) components 850. In this example, the software architecture 702 can be conceptualized as a stack of layers where each layer may provide a particular functionality. For example, the software architecture 702 includes layers such as an operating system 704, libraries 706, frameworks 708, and applications 710. Operationally, the applications 710 invoke application programming interface (API) calls 712 through the software stack and receive messages 714 in response to the API calls 712, consistent with some embodiments.

In various implementations, the operating system 704 manages hardware resources and provides common services. The operating system 704 includes, for example, a kernel 720, services 722, and drivers 724. The kernel 720 acts as an abstraction layer between the hardware and the other software layers, consistent with some embodiments. For example, the kernel 720 provides memory management, processor management (e.g., scheduling), component management, networking, and security settings, among other functionality. The services 722 can provide other common services for the other software layers. The drivers 724 are responsible for controlling or interfacing with the underlying hardware, according to some embodiments. For instance, the drivers 724 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

In some embodiments, the libraries 706 provide a low-level common infrastructure utilized by the applications 710. The libraries 706 can include system libraries 730 (e.g., C standard library) that can provide functions such as memory allocation functions, string manipulation functions, mathematic functions, and the like. In addition, the libraries 706 can include API libraries 732 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in graphic content on a display), database libraries (e.g., SQLite to provide various relational database functions), web libraries (e.g., WebKit to provide web browsing functionality), and the like. The libraries 706 can also include a wide variety of other libraries 734 to provide many other APIs to the applications 710.

The frameworks 708 provide a high-level common infrastructure that can be utilized by the applications 710, according to some embodiments. For example, the frameworks 708 provide various graphic user interface (GUI) functions, high-level resource management, high-level location services, and so forth. The frameworks 708 can provide a broad spectrum of other APIs that can be utilized by the applications 710, some of which may be specific to a particular operating system 704 or platform.

In an example embodiment, the applications 710 include a home application 750, a contacts application 752, a browser application 754, a book reader application 756, a location application 758, a media application 760, a messaging application 762, a game application 764, and a broad assortment of other applications, such as a third party applications 766. According to some embodiments, the applications 710 are programs that execute functions defined in the programs. Various programming languages can be employed to create one or more of the applications 710, structured in a variety of manners, such as object-oriented programming languages (e.g., Objective-C, Java, or C++) or procedural programming languages (e.g., C or assembly language). In a specific example, the third party application 766 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third party application 766 can invoke the API calls 712 provided by the operating system 704 to facilitate functionality described herein.

Some embodiments may particularly include a security application 767. In certain embodiments, this may be a stand-alone application that operates to manage communications with a server system such as intelligence data source(s) 150 or server system 102. In other embodiments, this functionality may be integrated with another application such as an email or messaging application or another such application. Security application 767 may facilitate sending requests for intelligence data and receiving intelligence data and related analysis. The security application 767 may provide the capability for a user to input data related to intelligence data and analysis via a touch interface, keyboard, or other mechanism of machine 800, communication with a server system via I/O components 850, and receipt and storage of analysis data in memory 830. Functionality related to sending requests for intelligence data and receiving intelligence data and related analysis can be managed by security application 767 using different frameworks 708, libraries 706 elements, or operating system 704 elements operating on a machine 800.

FIG. 8 is a block diagram illustrating components of a machine 800, according to some embodiments, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 816 (e.g., software, a program, an application 710, an applet, an app, or other executable code) for causing the machine 800 to perform any one or more of the methodologies discussed herein can be executed. In alternative embodiments, the machine 800 operates as a standalone device or can be coupled (e.g., networked) to other machines. In a networked deployment, the machine 800 may operate in the capacity of a server machine 102, 202, 204, 206, 208, 210, and so forth, or a client device 110 in a server-client network environment, or as a peer machine in a peer-to-peer (or distributed) network environment. The machine 800 can comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

In various embodiments, the machine 800 comprises processors 810, memory 830, and I/O components 850, which can be configured to communicate with each other via a bus 802. In an example embodiment, the processors 810 (e.g., a central processing unit (CPU), a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) include, for example, a processor 812 and a processor 814 that may execute the instructions 816. The term “processor” is intended to include multi-core processors 810 that may comprise two or more independent processors 812, 814 (also referred to as “cores”) that can execute instructions 816 contemporaneously. Although FIG. 8 shows multiple processors 810, the machine 800 may include a single processor 810 with a single core, a single processor 810 with multiple cores (e.g., a multi-core processor 810), multiple processors 812, 814 with a single core, multiple processors 810, 812 with multiples cores, or any combination thereof.

The memory 830 comprises a main memory 832, a static memory 834, and a storage unit 836 accessible to the processors 810 via the bus 802, according to some embodiments. The storage unit 836 can include a machine-readable medium 838 on which are stored the instructions 816 embodying any one or more of the methodologies or functions described herein. The instructions 816 can also reside, completely or at least partially, within the main memory 832, within the static memory 834, within at least one of the processors 810 (e.g., within the processor's cache memory), or any suitable combination thereof, during execution thereof by the machine 800. Accordingly, in various embodiments, the main memory 832, the static memory 834, and the processors 810 are considered machine-readable media 838.

As used herein, the term “memory” refers to a machine-readable medium 838 able to store data temporarily or permanently and may be taken to include, but not he limited to, random-access memory (RAM), read-only memory (ROM), buffer memory, flash memory, and cache memory. While the machine-readable medium 838 is shown, in an example embodiment, to be a single medium, the term “machine-readable medium” should be taken to include a single medium or multiple media (e.g., a centralized or distributed database, or associated caches and servers) able to store the instructions 816. The term “machine-readable medium” shall also be taken to include any medium, or combination of multiple media, that is capable of storing instructions (e.g., instructions 816) for execution by a machine (e.g., machine 800), such that the instructions 816, when executed by one or more processors of the machine 800 (e.g., processors 810), cause the machine 800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not he limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 850 include a wide variety of components to receive input, provide output, produce output, transmit information, exchange information, capture measurements, and so on. In general, it will be appreciated that the I/O components 850 can include many other components that are not shown in FIG. 8. The I/O components 850 are grouped according to functionality merely for simplifying the following discussion, and the grouping is in no way limiting. In various example embodiments, the I/O components 850 include output components 852 and input components 854. The output components 852 include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 854 include alphanumeric input components (e.g., a keyboard, a touch screen configured to receive alphanumeric input, a photo-optical keyboard, or other alphanumeric input components), point-based input components (e.g., a mouse, a touchpad, a trackball a joystick, a motion sensor, or other pointing instruments), tactile input components (e.g., a physical button, a touch screen that provides location and force of touches or touch gestures, or other tactile input components), audio input components (e.g., a microphone), and the like.

In some further example embodiments, the I/O components 850 include biometric components 856, motion components 858, environmental components 860, or position components 862, among a wide array of other components. For example, the biometric components 856 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 858 include acceleration sensor components (e.g., accelerometer), gravitation sensor components, rotation sensor components (e.g., gyroscope), and so forth. The environmental components 860 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 862 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 850 may include communication components 864 operable to couple the machine 800 to a network 880 or devices 870 via a coupling 882 and a coupling 872, respectively. For example, the communication components 864 include a network interface component or another suitable device to interface with the network 880. In further examples, communication components 864 include wired communication components, wireless communication components, cellular communication components, near field communication (NFC) components, BLUETOOTH® components (e.g., BLUETOOTH® Low Energy), WI-FI® components, and other communication components to provide communication via other modalities. The devices 870 may be another machine 800 or any of a wide variety of peripheral devices (e.g., a peripheral device coupled via a Universal Serial Bus (USB)).

Moreover, in some embodiments, the communication components 864 detect identifiers or include components operable to detect identifiers. For example, the communication components 864 include radio frequency identification (RFID) tag reader components, NFC smart tag detection components, optical reader components (e.g., an optical sensor to detect a one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D bar codes, and other optical codes), acoustic detection components (e.g., microphones to identify tagged audio signals), or any suitable combination thereof. In addition, a variety of information can be derived via the communication components 864, such as location via Internet Protocol (IP) geo-location, location via WI-FI® signal triangulation, location via detecting a BLUETOOTH® or NFC beacon signal that may indicate a particular location, and so forth.

In various example embodiments, one or more portions of the network 880 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the public switched telephone network (PSTN), a plain old telephone service (POTS) network, a cellular telephone network, a wireless network, a WI-FI® network, another type of network, or a combination of two or more such networks. For example, the network 880 or a portion of the network 880 may include a wireless or cellular network, and the coupling 882 may be a Code Division Multiple Access (CDMA) connection, a Global System for Mobile communications (GSM) connection, or another type of cellular or wireless coupling. In this example, the coupling 882 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

In example embodiments, the instructions 816 are transmitted or received over the network 880 using a transmission medium via a network interface device (e.g., a network interface component included in the communication components 864) and utilizing any one of a number of well-known transfer protocols (e.g., Hypertext Transfer Protocol (HTTP)). Similarly, in other example embodiments, the instructions 816 are transmitted or received using a transmission medium via the coupling 872 (e.g., a peer-to-peer coupling) to the devices 870. The term “transmission medium” shall be taken to include any intangible medium that is capable of storing, encoding, or carrying the instructions 816 for execution by the machine 800, and includes digital or analog communications signals or other intangible media to facilitate communication of such software.

Furthermore, the machine-readable medium 838 is non-transitory (in other words, not having any transitory signals) in that it does not embody a propagating signal. However, labeling the machine-readable medium 838 “non-transitory” should not be construed to mean that the medium 838 is incapable of movement; the medium 838 should be considered as being transportable from one physical location to another. Additionally, since the machine-readable medium 838 is tangible, the medium 838 may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
generating, at a server computer, intelligence data related to at least one of a group comprising: Internet Protocol (IP) addresses, email addresses, domain names, commercial mail receiving agencies, device identifiers, and user system activity;
storing, by the server computer, the intelligence data;
receiving, at the server computer, a registration request message from a user via a computing device, the registration request message comprising identifying information for the user, and identifying information for the computing device;
analyzing, by the server computer, the registration request message to determine whether the identifying information for the user and the identifying information for the computing device is associated with any data included in the intelligence data; and
sending, by the server computer, a registration response message indicating whether or not the user is registered, based on the result of analyzing the registration request message to determine whether the identifying information for the user and the identifying information for the computing device is associated with any data included in the intelligence data.

2. The method of claim 1, wherein the intelligence data is related to IP addresses, email addresses, domain names, commercial mail receiving agencies, device identifiers, and user system activity.

3. The method of claim 1, wherein before sending the registration response message, the method further comprising:
determining that the user should not be registered based on the result of analyzing the registration request message to determine whether the identifying information for the user and the identifying information for the computing device is associated with any data included in the intelligence data;
generating additional intelligence data based on the registration request message; and
storing the additional intelligence data.

4. The method of claim 1, wherein before sending the registration response message, the method further comprising:
determining that the user should be registered based on the result of analyzing the registration request message to determine whether the identifying information for the user and the identifying information for the computing device is associated with any data included in the intelligence data; and
causing a monitoring device to be installed on the computing device.

5. The method of claim 1, wherein the identifying information for the user comprises a name, email address, and password.

6. The method of claim 1, wherein the identifying information for the computing device includes a unique identifier associated with the computing device and an IP address associated with the computing device.

7. The method of claim 1, further comprising:
building a user profile utilizing the identifying information for the user and identifying information for the computing device.

8. The method of claim 1, further comprising:
determining that the user should be placed on a watch list based on the result of analyzing the registration request message to determine whether the identifying information for the user and the identifying information for the computing device is associated with any data included in the intelligence data.

9. The method of claim 1, further comprising:
receiving a system access request message;
determining the system access request message is related to the user;
analyzing the system access request message to determine whether the identifying information for the user and the identifying information for the computing device is associated with any data included in the intelligence data;
analyzing the system access request message to determine whether it conforms to user behavior based on a user profile for the user;
sending a system access response message indicating whether or not the user is authorized to access the system based on the result of the analyzing the system access request message to determine whether the identifying information for the user and the identifying information for the computing device is associated with any data included in the intelligence data, and the analyzing the system access request message to determine whether it conforms to user behavior based on a user profile for the user.

10. The method of claim 1, wherein the intelligence data is generated from multiple sources, and the method further comprises:
periodically requesting updated intelligence data; and
storing the updated intelligence data.

11. The method of claim 1, further comprising:
receiving an indication of system activity related to a user;
determining that the user is on a watch list; and
generating an alert indicating system activity related to the user.

12. The method of claim 11, further comprising:
receiving a request for intelligence data related to the user;
generating intelligence data related to the user; and
sending a response with the intelligence data related to the user.

13. A server computer comprising:
a processor; and
a computer-readable medium coupled with the processor, the computer-readable medium comprising instructions stored thereon that are executable by the processor to cause a computing device to perform operations comprising:
generating intelligence data related to at least one of a group comprising: Internet Protocol (IP) addresses, email addresses, domain names, commercial mail receiving agencies, device identifiers, and user system activity;
storing the intelligence data;
receiving a registration request message from a user via a computing device, the registration request message comprising identifying information for the user, and identifying information for the computing device;
analyzing the registration request message to determine whether the identifying information for the user and the identifying information for the computing device is associated with any data included in the intelligence data; and
sending a registration response message indicating whether or not the user is registered, based on the result of analyzing the registration request message to determine whether the identifying information for the user and the identifying information for the computing device is associated with any data included in the intelligence data.

14. The server computer of claim 13, wherein before sending the registration response message, the operations further comprising:
determining that the user should not be registered based on the result of analyzing the registration request message to determine whether the identifying information for the user and the identifying information for the computing device is associated with any data included in the intelligence data;
generating additional intelligence data based on the registration request message; and
storing the additional intelligence data.

15. The server computer of claim 13, wherein before sending the registration response message, the operations further comprising:
determining that the user should be registered based on the result of analyzing the registration request message to determine whether the identifying information for the user and the identifying information for the computing device is associated with any data included in the intelligence data; and
causing a monitoring device to be installed on the computing device.

16. The server computer of claim 13, the operations further comprising:
building a user profile utilizing the identifying information for the user and identifying information for the computing device.

17. The server computer of claim 13, the operations further comprising:
determining that the user should be placed on a watch list based on the result of analyzing the registration request message to determine whether the identifying information for the user and the identifying information for the computing device is associated with any data included in the intelligence data.

18. The server computer of claim 13, the operations further comprising:
receiving a system access request message;
determining the system access request message is related to the user;
analyzing the system access request message to determine whether the identifying information for the user and the identifying information for the computing device is associated with any data included in the intelligence data;
analyzing the system access request message to determine whether it conforms to user behavior based on a user profile for the user;
sending a system access response message indicating whether or not the user is authorized to access the system based on the result of the analyzing the system access request message to determine whether the identifying information for the user and the identifying information for the computing device is associated with any data included in the intelligence data, and the analyzing the system access request message to determine whether it conforms to user behavior based on a user profile for the user.

19. The server computer of claim 13, further comprising:
receiving a request for intelligence data related to the user;
generating intelligence data related to the user; and
sending a response with the intelligence data related to the user.

20. A non-transitory computer-readable medium comprising instructions stored thereon that are executable by at least one processor to cause a computing device to perform operations comprising:
generating intelligence data related to at least one of a group comprising: Internet Protocol (IP) addresses, email addresses, domain names, commercial mail receiving agencies, device identifiers, and user system activity;
storing the intelligence data;
receiving a registration request message from a user via a computing device, the registration request message comprising identifying information for the user, and identifying information for the computing device;
analyzing the registration request message to determine whether the identifying information for the user and the identifying information for the computing device is associated with any data included in the intelligence data; and
sending a registration response message indicating whether or not the user is registered, based on the result of analyzing the registration request message to determine whether the identifying information for the user and the identifying information for the computing device is associated with any data included in the intelligence data.
